(19) United States
(12) Patent Application Publication
(10) Pub. No.: US 2003/0148051 A1
(43) Pub. Date: Aug. 7, 2003

(54) Elasticated netting

(76) Inventor: Stuart Baird Revill, Swadlincote (GB)

Correspondence Address: AKERMAN SENTERFITT, P.O. BOX 3188, WEST PALM BEACH, FL, 33402-3188, US

(21) Appl. No.: 10/068,332

(22) Filed: Feb. 5, 2002

(51) Int. Cl. B32B 1/08; D05B 93/00; D05B 11/00; D05B 13/00; D05B 15/00; D05B 23/00; A21D 10/02; A23G 1/00; A23L 1/00; A21D 2/00; A22C 5/00

(52) U.S. Cl. 428/36.1; 428/57; 428/102; 112/413; 112/475.08; 426/129; 426/135

(57) ABSTRACT

A product such as a joint of meat is encapsulated in a cut length of a continuous sleeve of elasticated netting. A seam has been sewn along the sleeve offset from its centre so that the cut length has a lateral projection which will not become embedded in the product during cooking and can be used in handling the hot product. Preferably the seam is sewn using stitches which will unravel when one end of the yarn is pulled to facilitate stripping the sleeve from the product.

### BACKGROUND OF THE INVENTION

Elasticated netting is knitted as a continuous sleeve which, in an unstressed condition, is of smaller diameter than a meat or plant product to be encapsulated. The sleeve is expanded to allow insertion e.g. of a joint of meat and then released so that it grips the meat, preventing it from falling apart during handling and cooking.

After the meat is cooked there is the problem of disposing of the netting, which of course is inedible. After cooking the net is brittle and furthermore tends to be embedded in the meat, making it difficult to strip away cleanly in a single operation. The netting does not assist in handling the hot meat.

A principal object of the present invention is to facilitate the removal of the netting after cooking and to provide a means of handling the cooked, netted product without the need for gloves or tools such as forks.

### SUMMARY OF THE INVENTION

In accordance with the present invention a sleeve of elasticated netting is provided with a seam such that when a product is encapsulated by the sleeve a portion of the sleeve will project from the product and will not become embedded in the surface of the product when it is cooked. This projecting portion can therefore be grasped and used to lift embedded areas of the sleeve, enabling them to be cut so that the sleeve can be stripped from the product. Because of the low heat retention of the netting it will not be essential to use gloves or some instrument such as a fork when grasping the projecting portion, which can be used to lift the cooked product e.g. from an oven onto a dish before cutting the sleeve and stripping it.

Conveniently the seam will extend longitudinally of the sleeve offset from the centre of the sleeve, so that the projection will be a small proportion of the width of the sleeve isolated by the seam from the remainder of the sleeve. The seam can thus be sewn into the sleeve as it emerges continuously from storage means and before being cut roughly to the length of a product being encapsulated. In this way each cut length encapsulating a product has a projection throughout its length, and opposite ends of the projection can be grasped when lifting the product. To strip the netting it will be cut alongside one side of the projection, using the projection to lift the embedded netting to assist in cutting it. Once severed along the length of the product the latter can be rolled out of the netting as it is pulled away from the product using the projection.

Preferably the seam is sewn using stitches which will unravel when an end of the yarn is pulled. Abolition of the seam will loosen the sleeve, assisting its cutting and removal but there will remain portions of the sleeve not in contact with the cooked product and therefore possible to grip without burning oneself.

### BRIEF DESCRIPTION OF THE DRAWINGS

A preferred embodiment of the invention will now be described with reference to the accompanying drawings, in which:

FIGS. 1 and 2 both illustrate a joint of meat encapsulated or contained in a cut length of a sleeve of elasticated netting, the sleeve being provided with a seam in accordance with the present invention.

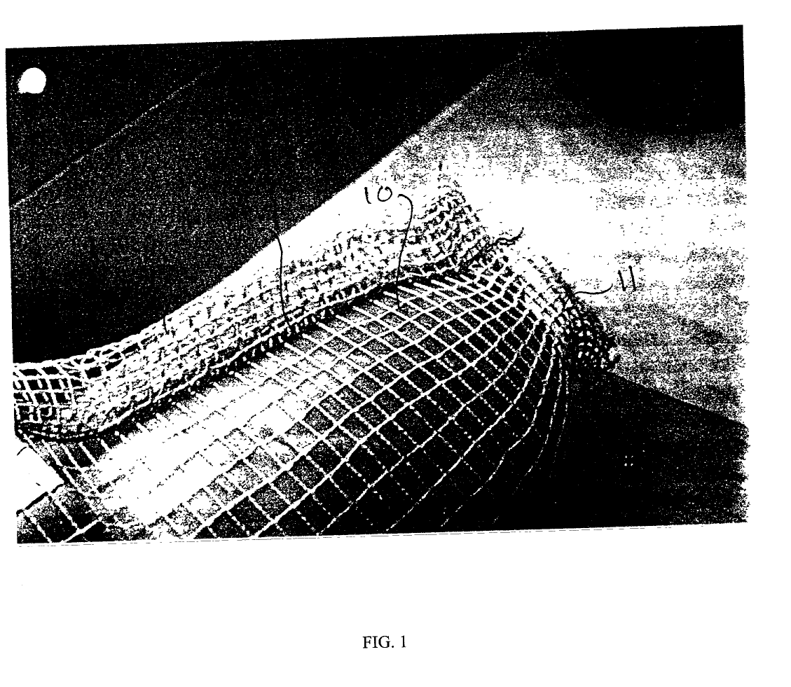

### DETAILED DESCRIPTION OF THE PREFERRED EMBODIMENTS

A joint of meat 10 has been encapsulated in known manner in a cut length 11 of a sleeve of elasticated netting. As is known per se the sleeve has been knitted using rubberised yarn on a circular knitting machine so that in the unstressed condition of the sleeve it is of smaller diameter than the joint 10. It has been expanded to allow insertion of the joint and then allowed to contract so that it embraces the meat and keeps it whole during handling and cooking.

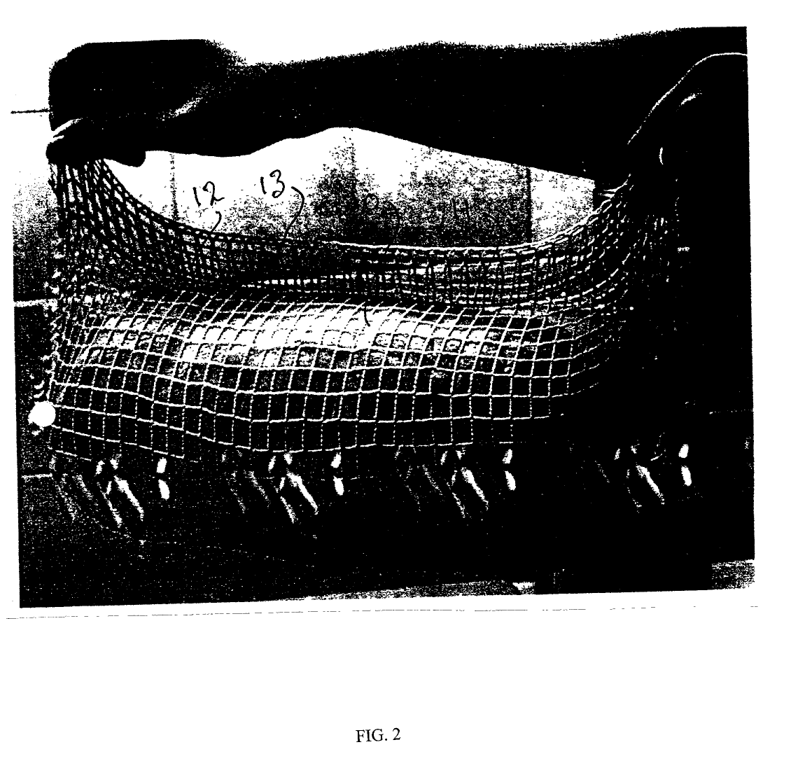

In accordance with the present invention a longitudinal seam 12 has been sewn along the length of the sleeve so as to isolate a small proportion of the width of the sleeve as a projection 13 extending from end to end of the cut length 11. This projection 13 will not become embedded in the surface of the joint 10, as will the remainder of the sleeve, when the joint is cooked. Most of the projection 13 will not be in contact with the meat and will rapidly cool enabling the still very hot joint 10 to be moved after cooking e.g. by grasping opposite ends of the projection 13 as illustrated in FIG. 2.

To strip the sleeve 11 from the cooked meat the projection 13 is pulled up to separate portions of the sleeve adjacent the seam 13 from the meat. The sleeve can thus be cut, using a knife or scissors, parallel with the seam 12 on one side of the projection 13, which is then pulled away from the joint, causing it to rotate as the sleeve is stripped. It should be noted that in this operation it is much more likely that the whole of the sleeve will be removed from the joint in a single piece than in former practice.

Thus the projection 13 serves not only as a means of handling the cooked joint without burning oneself but more importantly as a means of removing the sleeve from the cooked meat cleanly and easily.

The seam 12 is preferably sewn using stitches which unravel when the yarn is pulled lengthwise of the joint. By unravelling the seam 12 the sleeve as a whole is loosened, making it easier to cut.

The projection 13 does not have to extend from end to end of the joint. One or more seams could be sewn transversely of the sleeve to provide one or more “tabs”. If desired the sleeve could have more than one longitudinal projection 13 at a circumferentially spaced location.

1. A sleeve of elasticated netting provided with a seam such that when a product is encapsulated by the sleeve a portion of the sleeve will project from the product and will not become embedded in the surface of the product when it is cooked.

2. A sleeve as claimed in claim 1, wherein the seam extends longitudinally of the sleeve offset from the centre of the sleeve, so that the projection is a small proportion of the width of the sleeve isolated by the seam from the remainder of the sleeve.

3. A sleeve as claimed in claim 2, wherein the seam is sewn with stitches which will unravel when an end of the yarn is pulled.

4. A method of manufacturing the sleeve claimed in claim 1, the method comprising sewing into the sleeve as it emerges continuously from storage means a longitudinal seam offset from the centre of the sleeve, encapsulating a product in the larger diameter portion of the sleeve and cutting the sleeve roughly to the length of the product whereby the smaller diameter portion of the sleeve on the opposite side of the seam to the product provides a lateral projection which will not become embedded in the product and can be used for handling the same.

5. A method as claimed in claim 4, wherein the seam is sewn using stitches which will unravel when a cut end of the yarn is pulled.
